(19) United States
(12) Patent Application Publication
(10) Pub. No.: US 2022/0396524 A1
(43) Pub. Date: Dec. 15, 2022

(54) Fluid for Stabilising Solids

(71) Applicant: VitriTech Ltd, Tinsley (GB)

(72) Inventors: Christopher HOLCROFT, Chapeltown, Sheffield (GB); Martyn MARSHALL, Chapeltown, Sheffield (GB); Malcolm GLENDENNING, Chapeltown, Sheffield (GB); Brian NOBLE, Chapeltown, Sheffield (GB)

(73) Assignee: VitriTech Ltd, Tinsley (GB)

(21) Appl. No.: 17/642,871

(22) PCT Filed: Oct. 1, 2020
(86) PCT No.: PCT/GB2020/052398

§ 371 Date: Mar. 14, 2022

(30) Foreign Application Priority Data
Oct. 4, 2019 (GB) 1914405.4

(51) Int. Cl. C04B 14/22; C03C 8/16; C03C 8/08; C09K 17/12; C03B 19/10

(52) U.S. Cl. CPC C04B 14/22; C03C 8/16; C03C 8/08; C09K 17/12; C03B 19/10; C04B 2111/2038

(57) ABSTRACT

A fluid for stabilising solids formed from particulate material, the fluid comprising glass and a carrier. A method for preparing the fluid comprising melting and fritting a glass, milling the glass to form a powder and adding the milled glass to a carrier. A method of stabilising a solid formed from particulate material, the method comprising the steps of mixing the fluid with a particulate material and setting, and the use of the fluid, in geoengineering, building preservation, construction, tunnelling, landscape restoration, land remediation, and/or flood protection/remediation.

The invention relates to a fluid for stabilising solids which are formed from particulate material, in particular, to fluids which promote glass forming reactions within the porous structure of a particulate material.

Solids formed from particulate material are prone to degradation, wherein the particles break free of the solid and are either lost to the solid or react to alter the properties of the solid in an undesirable way. Examples of this would be the natural erosion of sedimentary rock faces, or soils on hillsides, through exposure to the wind and the rain. Such erosion is of particular concern in and around water courses, where rock and/or soil breakdown is significantly more rapid. Similar erosion can occur in man-made structures, such as buildings or bridges, whereby the bricks or concrete from which they are formed break down as a result of not only the wind and rain, but also to pollutants now commonly found in urban areas.

Further, in the extraction of materials such as oil and natural gas from rock formations, the breakdown of the solid (for instance the formation of sand from sandstone, or chalk dust released from limestone deposits) can block small and large fissures or pores in the rock, preventing the flow of the extraction stimulation fluid (for instance, water or a light alkane), or of the oil or gas, through the rock. This increases the cost of extraction as access to the deposit is reduced. Further, the loose particulate material will often become suspended in the stimulation fluid, oil or gas stream, being carried from the rock into the processing machinery, causing blockages that result in extraction downtime and which reduce the longevity of the equipment.

One method of preventing the blocking of the fissures is described in WO 2018/029457 which discloses the use of silica glass proppants, not to strengthen the rock (e.g. sandstone or shale) substrate, or to prevent it's degradation into fine particulates, but to prop open the fissures ensuring that these do not self-seal under gravity. In this way, the flow of stimulation fluid and the oil/gas is maintained, although there is an inevitable reduction in flow rate as the proppant partially blocks the fissure.

It can also be desirable to seal the solid formed from particulate material; for instance closing any fissures or pores in rock, to prevent the flow of fluids therethrough. This can be beneficial in the construction industry, as it provides for the possibility of using initially porous materials in applications where the ultimate surface must be water tight. It can also be beneficial in the tunnelling industry, reducing water ingress into the tunnel cavity, for instance via the ceiling of the tunnel. Further, the provision of an alternative to the use of cement in the sealing of spent oil and gas extraction sites and well bores, particularly if this were low cost and/or low environmental impact, would be beneficial.

U.S. Pat. No. 5,221,497 describes colloidal silica which may be used to strengthen soft or weak ground, the silica being formed into a grouting solution which is injected into the substrate. The use of colloidal silica, prepared using a sol-gel process, provides for a relatively complex and costly manufacturing process.

U.S. Pat. No. 7,964,538 describes a synthetic glass as a replacement for blast furnace slag in cement slurries for oil well sealing. The glass is intended for use where blast furnace slag is not readily available and is incorporated into existing oil well sealing technologies as a simple substituent for the slag.

It is therefore desirable to provide a method and material which can seal pores or voids in particulate solids such that they are substantially impermeable and/or which can stabilise the solid to reduce degradation without significant loss of permeability. The invention is intended to overcome or ameliorate at least some aspects of these problems.

Accordingly, in a first aspect of the invention there is provided a fluid for stabilising solids which are formed from particulate material, the fluid comprising glass and a carrier. The fluid has been found to stabilise a range of particulate solids without the need for the use of complex mixtures. In particular, it has been found to be possible to stabilise the solid without loss of permeability, because the voids (e.g. pores or channels) are not blocked, by support materials (such as proppants), or by the particulate released during erosion of the solid. Alternatively, it has been possible to use the fluid to stabilise the solid by sealing it, and closing the pores. As such, as used herein the word “stabilising” and related terms, comprises sealing the solid formed from particulate material or stabilisation without substantial loss of permeability (for instance, reduction in permeability may be 0% relative to permeability in the absence of the fluid, or it may be in the range 0.01-30%, or 0.1-20% or 1-10%). In both cases stabilisation typically results in strengthening of the solid, in that not only is erosion reduced or prevented, but also that the solid is capable of withstanding greater pressure before it becomes deformed. In oil and gas extraction applications, this provides for the pumping of the extraction fluid at higher pressures, extending well lifetimes and providing for increased recovery.

For the avoidance of doubt the terms “particulate solid”, “solid formed from particulate material” and “solid which is formed from particulate material” are used interchangeably herein. The term “fluid” is intended to include any combination of the glass and the carrier, whether formed at the point of use, or whether the fluid is pre-prepared. When the fluid is pre-prepared, it could also be referred to as a product for stabilising solids. The pre-preparation of the product would include any formation of the product prior to introduction to the particulate solid, be this at a manufacturing site such that the product is shipped “ready to use”, or ready to use subject to dilution; or be this at the location of use, where, for instance, the glass is dissolved or suspended in the carrier just prior to introduction to the solid.

It will often be the case that the fluid comprises a solution of glass or a suspension of glass powder in a liquid carrier, although gaseous carriers may occasionally be used liquid systems are easier to handle, and store. Often the fluid comprises a saturated solution of glass in a liquid carrier. As the skilled person will be aware, it is generally the case that saturated solutions include trace levels of solid, as this is necessary to ensure that the solution is saturated. However, such saturated solutions are not to be considered suspensions as described above. Typical concentrations of glass in solution or suspension would be in the range 1-15 wt %, often 2.5-10 wt % of the fluid. A saturated solution would often be of concentration in the range 15-20 wt %.

The fluid may stabilise the particulate solid through physical interaction and/or chemical reaction with the particulate material. For instance, the fluid may gel or set in situ, providing a physical “glue” between the particles. This is often the case where the fluid is intended to seal the particulate solid, closing all pores, cracks and fissures. Alternatively, a chemical reaction may occur between the glass and the particulate material. This reaction may be a glass forming reaction, whereby the glass component of the fluid is modified. Examples of this include:
Carbonate substrates such as chalk or limestone reacting with phosphate glasses to form calcium phosphate minerals for example apatite-type minerals
Carbonate substrates such as chalk or limestone reacting with Sulphate containing glasses to form gypsum-type minerals
Silicate substrates such as sandstone reacting with phosphate glasses to form apatite-type minerals

What is notable, is that the glass is generally “functional” such that it reacts to interact with the particulate material. As described above, this may be through direct chemical reaction with the particulate, and/or through a chemical change in the glass which results in physical interaction with the particulate. Different solids are formed from particulates of different particle sizes, and as a result different porosities. In addition, different materials inherently include more or less fissures or cracks dependent upon the internal stresses to which they are subject. It will, however, generally be the case that the particle size distribution of the particulate material is in the range 0.01 μm to 2 mm, often in the range 0.5 μm to 1 mm. Particle sizes are measured across the longest axis of the particle. These particle sizes are such that the material will be generally porous and so capable of interacting with the fluid.

It is desirable for the fluid to be compatible with a wide range of solids, in particular, particulate solids selected from sedimentary rock, soil (including sediment), or construction materials formed from particulate matter. Often the rock will be selected from chalk, sandstone, limestone and shale, and the building material from bricks, stone, cement and concrete. For the extraction of oil and gas, the sedimentary rock is often selected from chalk, shale, halides and sandstone, as it is these rock types which degrade most easily under extraction conditions.

The particle size distribution of chalk particulates is often in the range 0.5 μm to 100 μm; of sandstone in the range 50 μm to 2 mm; of soil in the range 2 μm to 2 mm and of brick dust in the range 0.01 μm to 1 mm, although each material comprises a complex mixture of components and different samples will inevitably have differing particle size distributions which may be monomodal, bimodal or multimodal.

The mean particle size of the particulate material forming the solid is often in the range 1 μm to 1 mm, with chalk having a mean particle size in the range 10 μm to 50 μm, sandstone in the range 0.5 mm to 1 mm, brick in the range 0.5 μm to 0.5 mm and soil in the range 5 μm to 1.5 mm.

It will often be the case that where the glass is a suspension of glass powder in the carrier, the particle size distribution of the glass particles is ±15% or ±10% of the particle size distribution of the particulate material to ensure that the glass powder is of comparable or smaller size than the majority of the pores or fissures in the particulate material, thereby ensuring good permeation into the material. This may mean that the particle size distribution of the glass powder is in the range 1 μm to 5 mm, often 10 μm to 2 mm. In particular, it has been found that glass particle sizes of less than 5 mm are excellent at sealing sandstone. Further, smaller particle sizes aid dissolution of the glass in the carrier. The mean particle size distribution of the glass powder may be in the range 1 μm to 50 μm, this is particularly the case where the suspension is intended to seal chalk or limestone, as it has been found that particle sizes in the range 1 μm to 45 μm are optimal for sealing this rock as it is formed from a very fine particulate material. The particle size distribution may further be in the range 1 μm to 10 μm, in this range the glass powder has been found to strengthen the particulate solids without significant loss of porosity.

It will often be the case that the glass is a low melting point glass, optionally with low durability. Low melting point glasses are easy to process and their powders can, if needed, be melted in situ to aid setting of the fluid and stabilisation of the solid. A typical melting point range for the glasses will be less than 1200° C., often in the range 900-1100° C. Selecting a glass of low durability also aids processing and fluid formation, as the glass is easily powdered and is generally more soluble. A low durability glass would typically dissolve in water at standard temperature and pressure in less than 4 hours, typically in the range 0.5-4 hours, often in around 45-75 minutes, or around 1 hour.

The glass will often be selected from sodium (Na₂O), potassium (K₂O), lithium (Li₂O), sulfate (SO₄), phosphate (P₂O₅) glasses and combinations thereof. These glasses have good solubility providing for solution delivery rather than suspension delivery if desired, they are highly reactive, offering the possibility of glass forming or other chemical reactions within the particulate solid and they are generally of low melting point (for instance, less than 1100° C.). Of these, potassium glasses have been found to impart the particulate solid with excellent strength. Lithium, sodium and potassium glasses all offer good reduction in porosity, and so have potential utility in sealing applications, whilst phosphate glasses improve the stability and porosity of the solid, offering utility in stabilisation applications. Often the glass will be selected from a silicate or a phosphate glass. Silicate glasses have been found to be excellent in sealing applications, whereas phosphate glasses work very well where the stabilisation is strengthening whilst retaining permeability. The glass may comprise an oxide selected from SiO₂, Al₂O₃, Fe₂O₃, SO₃, Li₂O, Na₂O, MgO, ZnO, CaO, PbO, PbO₂, BaO, P₂O₃, P₂O₅ or combinations thereof. Often SiO₂, MgO, Na₂O, ZnO, CaO, PbO or combinations thereof will be present.

All of the above glasses may be formulated to be soluble or insoluble in the carrier and may therefore be present in solution or suspension as required.

The glass may be a phosphate glass additionally comprising one or more oxides selected from MgO, CaO, Na₂O, SiO₂, PbO and ZnO. The presence of MgO and/or CaO is beneficial to promote chemical reaction with the particulate solid. For instance, where the solid is low in calcium, CaO promotes the reaction of the glass to form apatites. CaO may form part of the initial phosphate glass composition, or be added to the solid later (in some cases as CaCO₃ which reacts to form CaO). Apatite-type minerals have been found to be particularly good at strengthening the solids without loss of permeability. Na₂O retards the setting of the fluid, allowing time for the fluid to permeate through the solid before setting occurs. SiO₂ improves the durability of the glass, PbO reduces the viscosity and working temperature of the glass, Fe₂O₃ and ZnO aid the processing of the glass mixture during manufacture. Often the phosphate glass will comprise at least ZnO and MgO in addition to the phosphate base. Alternatively, the phosphate glass may comprise Na₂O and CaO, optionally with low levels of SiO₂.

Typically, in a phosphate glass the phosphate will be present at levels in the range 50-90 wt %, often 65-85 wt %. Within this range the phosphate may be present at levels in the range 65-75 wt %, often 65-70 wt %, or often 70-85 wt % or 75-80 wt %, dependent upon the levels of the other components present. Where present, ZnO will often be present in 15-35 wt %, often 20-30 wt %. Within this range the ZnO may be present in the range 20-25 wt %, often 20-22 wt %, or in the range 25-30 wt %, often 27-29 wt % depending on the level of phosphate present. Where present, MgO will often be present in lower levels, such as in the range 0.5-5 wt %, often 1.5-4 wt %. SiO₂ is sometimes present as a minor component in phosphate glasses, where present it will generally be present in the range 1-10 wt %, often 3-7 wt %. Fe₂O₃ can be present in the range 5-10 wt %, often 7-9 wt %.

The glass may be a silicate glass, optionally additionally comprising one or more oxides selected from Na₂O, Li₂O, and CaO. Na₂O improves the solubility of the glass, Li₂O aids processing of the glass mixture during manufacture, CaO assists in the reaction of the fluid to seal pores of the solid and improves the durability, balancing the solubility of the silicate and Na₂O. However, it has been found that only small amounts of CaO are required, typically in the range 0.5-25 wt %, often 1-10 wt %, often 2-8 wt %, or 4-7 wt % in order to provide the optimal seal. Where present, Na₂O is typically present in the range 5-45 wt %, or 25-45 wt %, often in the range 30-40 wt %. Silicate will typically be present in the range 50-90 wt %, often 70-85 wt %, often 75-80 wt %.

Importantly, a combination of glasses may be present in the fluid, for instance a combination of both silicate and phosphate glasses may be used. Therefore, the sodium, potassium, lithium, sulfate or phosphate glasses may be present alone, in binary combinations, ternary combinations or more. Where present in binary combinations the glasses may be present in ratio ranges of 1:10 to 10:1, often in the range 3:1 to 1:3, often around 1:1, for instance, in the range 1:2 to 2:1.

Typical silicate glass compositions would be:
50-60 wt % SiO₂, 40-50 wt % LiO₂
80-85 wt % SiO₂, 15-20 wt % LiO₂
50-70 wt % SiO₂, 30-45 wt % Na₂O, 1-8 wt % CaO
60-70 wt % SiO₂, 25-35 wt % Na₂O, 4-7 wt % CaO
60-70 wt % SiO₂, 23-35 wt % Na₂O, 4-7 wt % CaO

Typical phosphate glass compositions would be:
75-80 wt % P₂O₅, 20-25 wt % ZnO, 1.5-5 wt % CaO
73.5-80 wt % P₂O₅, 18.5-25 wt % ZnO, 1.5-5 wt % CaO
65-80 wt % P₂O₅, 20-30 wt % ZnO, 1.5-5 wt % MgO
73.5-80 wt % P₂O₅, 18.5-25 wt % ZnO, 1.5-5 wt % MgO
65-75 wt % P₂O₅, 1-25 wt % CaO, 3-30 wt % Na₂O, 0-8 wt % SiO₂, 0-25 wt % PbO
65-75 wt % P₂O₅, 15-25 wt % CaO, 5-8 wt % Na₂O, 3-6 wt % SiO₂
65-75 wt % P₂O₅, 1-10 wt % CaO, 20-30 wt % Na₂O

The glass may also contain ancillary agents such as fining agents, tracers, colourants, and antimicrobials.

The carrier is generally selected from a low viscosity liquid such as water, brine or an alkaline solution, for instance sodium hydroxide or ammonium hydroxide at concentrations in the range 0.05-0.2M, often around 0.1M. The brine may have a concentration of sodium chloride in water of in the range 1-10 wt %, although often the brine will be simulated (or natural) seawater having a concentration of sodium chloride in water in the range 2-5 wt %, often 3-4 wt %. These carriers provide for easy pumping of the fluid into the solid and are selected for their ready availability. Alkali is generally added to enhance dissolution of the glass powder.

The carrier may additionally comprise processing aids, such as humectants, stabilising agents, and the like. The humectant may include polyols (such as glycerol), glycols (such as propylene glycol), polyolesters (such as triacetin) and combinations thereof. Where present, the humectant will often be present in the range 1-10 wt %, often 1-5 or 3-5 wt % of a solution or suspension of the glass in the carrier. It has been found by the applicant that the addition of a humectant, such as glycerol, can facilitate formation of the fluid by facilitating mixing between the carrier and the glass. Where the ratio of humectant:glass is high (for instance at or around 1:1, for instance in the range 1:2-3:2) a clear end solution can be formed, with minimal or no precipitate.

In a second aspect of the invention there is provided a method for preparing a fluid for stabilising solids formed from particulate material comprising melting and fritting a glass, milling the glass to form a powder and adding the milled glass to a carrier. This prepares a fluid of the first aspect of the invention. The method has been found to offer a simple and economical method of preparing glass powders, which can be easily scaled up for bulk production. The glass may be dissolved in the carrier or suspended in the carrier dependent upon the glass composition selected.

It may be that the glass powder is prepared and stored for later use, such that the fluid is not prepared by adding the glass to the carrier until shipping or even until the glass arrives at the point of use. This can reduce the volume of material needed for storage and shipping, reducing storage and/or transport costs and the carbon footprint of fluid use. However, it will often be the case, that to avoid shipping fine particulate materials, the fluid will at least partially be prepared to “wet” the glass, providing for easier transport. For instance, the glass:carrier may be provided for transport as a 10:100-50:100 suspension/solution, often as a 20:100 suspension/solution which may be further diluted at the point of use. As such, it is typical that the fluid will be formed prior to contact with the solid. Formation will generally be by dissolution or suspension of the glass in the liquid carrier.

There is provided, in a third aspect of the invention, a method of stabilising a solid formed from particulate material, the method comprising the steps of mixing the fluid of the first aspect of the invention with a particulate solid and setting. The mixing may be achieved in many ways, depending upon the specific application of fluid use. For instance, mixing will often comprise pumping or injecting the pre-prepared fluid into the solid, as may be the case for solids containing oil or gas deposits, or building preservation. Mixing may also comprise submerging the solid formed from particulate material in the fluid, as may be the case where the solid is an artistic work that it is desired to preserve, or in the pre-treatment of construction materials. Alternatively, the fluid may be formed in situ by mixing the glass directly with the solid in powder form and allowing the glass to dissolve and react with ambient water. This may be the case where the solid formed from particulate material is soil. Further, the powdered glass may be blown into the pores of the particulate solid using air, and again allowed to react with, for instance, atmospheric water, to create the fluid.

As described above, often stabilisation of the solid comprises sealing pores in the solid such that it is impermeable. Alternatively, stabilisation of the solid may comprise strengthening the solid to reduce degradation without any, or any significant, loss of permeability.

The step of setting the mixture of the fluid and the solid may be heat setting, chemical setting or simply setting through the elapse of time under ambient conditions. Setting may be as a result of chemical reaction with the particulate solid, or of physical interaction as described above. Without being bound by theory, it is believed that one form of setting may be through the formation of a glass gel within the pores of the solid which is formed from particulate material. This would result in the sealing of the solid. For instance, in a calcium substrate, such as chalk, the fluid may promote ion exchange within the solid, such that calcium ions migrate into the fluid, and are exchanged with, for instance, sulfate or phosphate ions which migrate into the solid. This can promote surface reactions, and even crystal growth within the pores. Where crystal growth is observed, the sealing is particularly good as the crystal growth is generally expansive, creating pressure within the solid such that a highly effective seal is formed.

Heat setting may be through the use of explosive charges, and chemical setting through the incorporation of a setting agent which may be present in the fluid, or added as a separate step. As such, the method may further comprise a step of adding a setting agent to the solid prior to setting. The setting agent may be glass of a composition different to the glass in the fluid and/or a non-glass material, for instance calcium carbonate may be added to stimulate a sealing reaction after conversion in situ to CaO. Further, the second step (or a further subsequent step) may comprise adding an antimicrobial component to the particulate material.

In addition, the method may comprise a first step wherein stabilisation is strengthening the solid to reduce degradation without loss of permeability, and a second step wherein stabilisation is sealing pores in the solid such that it is impermeable. Thus, there may a first step of stabilisation without loss of permeability, and a second step of sealing. This may be, for instance, where a particulate material requires stabilisation to allow extraction of oil or gas, and subsequent sealing of the solid after the oil and gas has been depleted and the “well” is no longer required.

In a fourth aspect of the invention there is provided the use of a fluid according to the first aspect of the invention in an application selected from geoengineering, building preservation, construction, tunnelling, landscape restoration, land remediation, sealing of leaking reservoirs and liquid storage ponds, and/or flood protection/remediation. Often, the fluid will be used in the construction industry, tunnelling industry or in geoengineering, such as to stabilise oil/gas wells and/or to seal these once the well is spent. It should be noted that in any application (for instance in the stabilisation of oil wells), more than one fluid may be used to achieve the optimum results. For instance, a first fluid that will stabilise without loss of porosity and one or more further fluids which seal may be used together. This may be where different areas of the particulate material substrate are of different composition (for instance different rock strata), or where different areas of the substrate must perform different functions (for instance in flood protection it may be desirable to seal some areas of the flood defence, whilst leaving others porous to allow drainage). Therefore, the use of the fourth aspect of the invention may comprise the use of a single fluid or of two or more different fluids in any given commercial application of the fluid.

Unless otherwise stated, each of the integers described may be used in combination with any other integer as would be understood by the person skilled in the art. Further, although all aspects of the invention preferably “comprise” the features described in relation to that aspect, it is specifically envisaged that they may “consist” or “consist essentially” of those features outlined in the claims. In addition, all terms, unless specifically defined herein, are intended to be given their commonly understood meaning in the art.

Further, in the discussion of the invention, unless stated to the contrary, the disclosure of alternative values for the upper or lower limit of the permitted range of a parameter, is to be construed as an implied statement that each intermediate value of said parameter, lying between the smaller and greater of the alternatives, is itself also disclosed as a possible value for the parameter.

In addition, unless otherwise stated, all numerical values appearing in this application are to be understood as being modified by the term “about”.

In order that the invention may be more readily understood, it will be described further with reference to the figures and to the specific examples hereinafter.

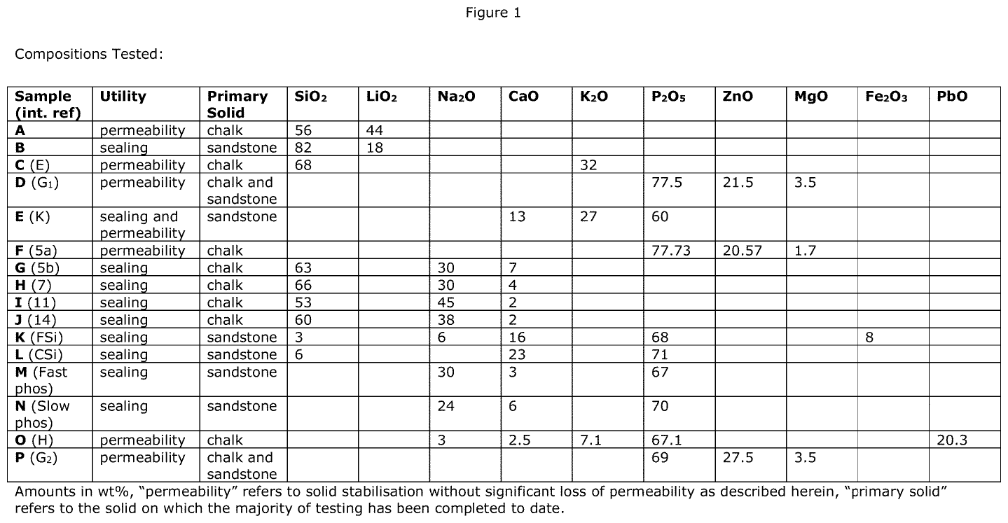

FIG. 1 is a table providing composition information for inventive glass compositions;

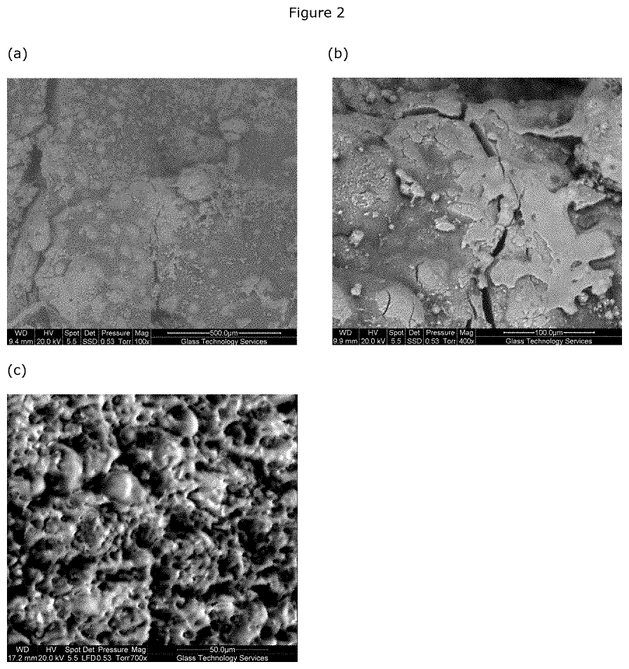

FIGS. 2a-c are SEM images at the magnifications 500 μm, 100 μm and 50 μm (a-c respectively) of the surface of a sealed chalk sample as described in Example 1;

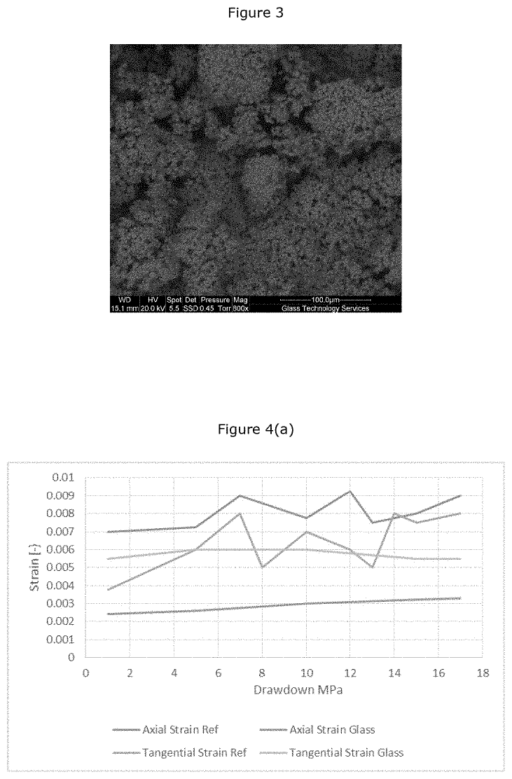

FIG. 3 is an SEM image at 100 μm magnification of an unsealed chalk sample;

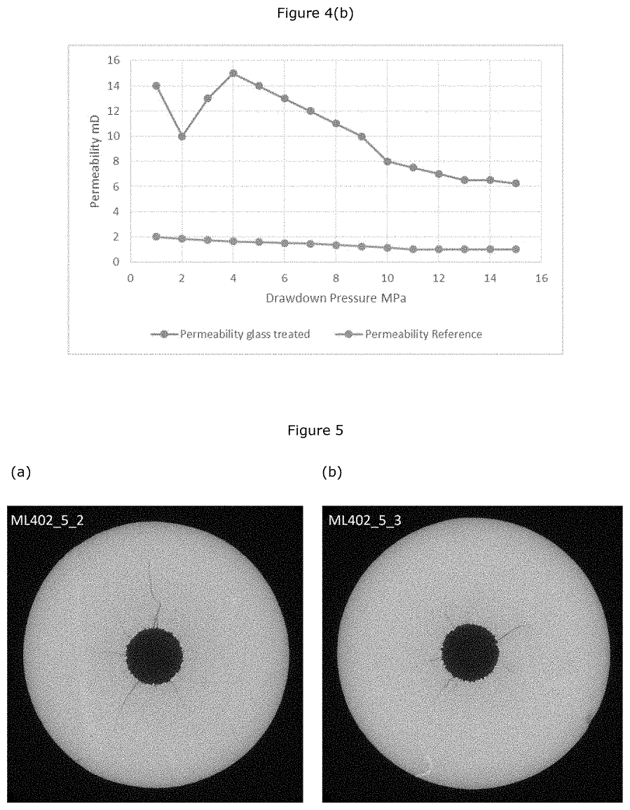

FIG. 4a compares the change in strain experienced by untreated chalk (reference, in both bands the upper line) and chalk treated as in Example 2 (new glass test, in both bands the lower line) for axial (lower band) and tangential (upper band) sections under increased drawdown pressures;

FIG. 4b compares the change in permeability of untreated chalk (reference, lower plot) and chalk treated as in Example 2 (new glass test, the upper plot) with increased drawdown;

FIGS. 5a and 5b are CT-scans comparing an untreated chalk sample (a) with a treated chalk sample (b);

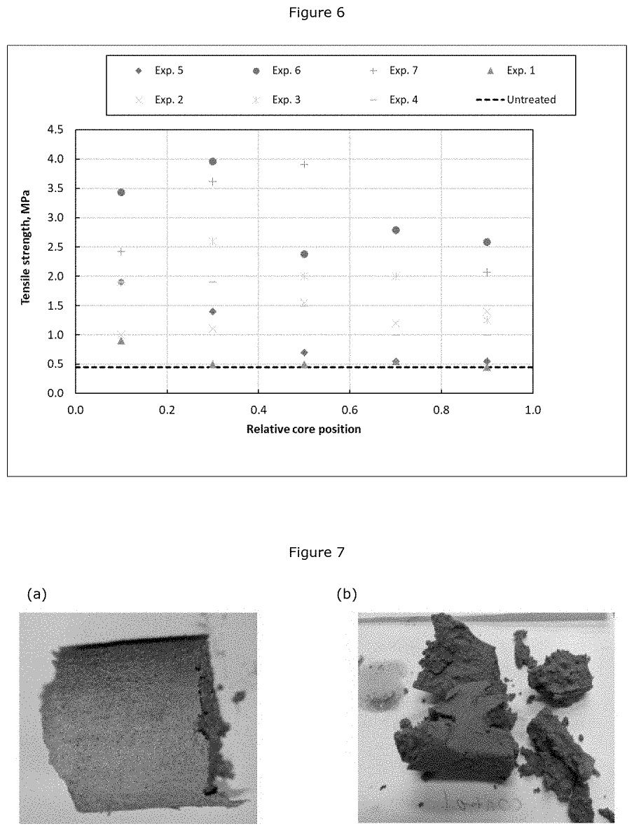

FIG. 6 compares the strength of chalk after injection with glass composition P in conjunction with sodium bromide brine at different injection pressures relative to a comparative glass composition in tap water by function of core length (5% glass solution in water, specific gravity 1.3, 90° C.). The inventive examples were injected under the following conditions (25-30 bar with up to 10 pore volumes (pv) of glass solution passing through the core; 26-7.5 bar, 7 pv; 27-14 bar, 9 pv; 29-30 bar, 10 pv, 30-25 bar, 10 pv);

FIGS. 7a and 7b are photographs of treated (a) and untreated (b) sandstone cores;

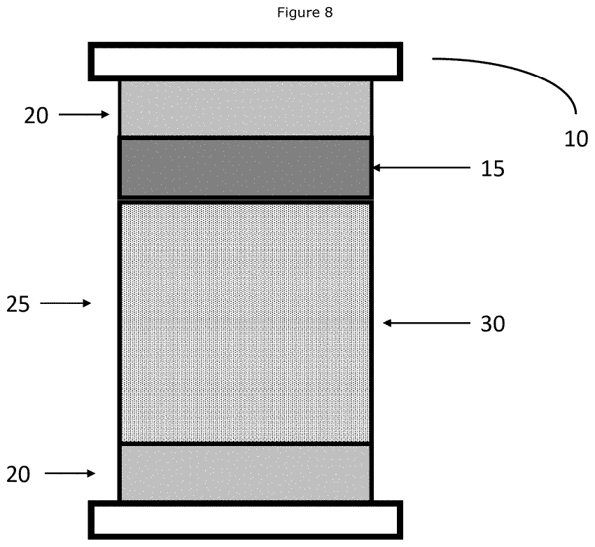

FIG. 8 is a schematic representation of a core forming apparatus used in Example 3;

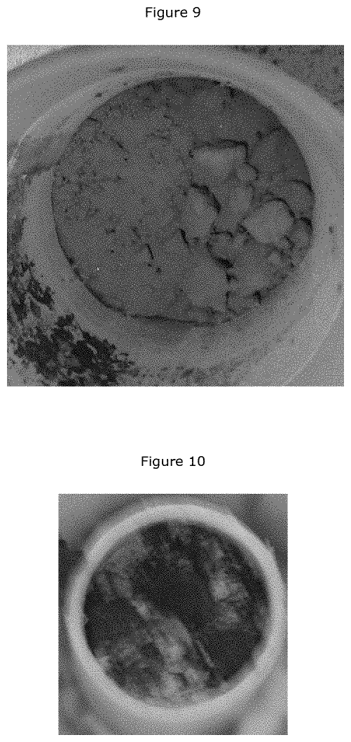

FIG. 9 is a photograph of crushed brick dust treated with glass to form a solid block as in Example 4; and

FIG. 10 is a photograph of a core of crumbled brick treated with a glass solution followed by a calcium carbonate solution to bind the brick particles together and form a seal as in Example 5.

### EXAMPLES

The Compositions tested are shown in FIG. 1, unless otherwise stated in the specific examples below, these were tested in water as the carrier. The glass samples were prepared by melt combination and ball milling and all were found to be effective for the purposed identified in the “utility” column, with at least the primary solid, often with both chalk and sandstone.

### Example 1: Stabilisation of Chalk (Sealing)

Chalk Core Preparation: Blocks of chalk were sourced from a disused chalk pit in the Thames Valley. These chalks were found to be 98% CaCO₃; cores were taken from the raw blocks with a 39 mm core drill, and the surfaces then ground flat. Both drilling and grinding were carried out using water as a lubricant. Core dimensions were then measured from which their volumes were calculated. The cores were then soaked in the appropriate glass solution until no further weight gain was measured, at which point they were assumed to be saturated. Based on a preliminary set of incremental measurements a time of 1 hour was chosen for soaking subsequent samples process. They were then air dried prior to testing.

Porosity Measurement: Samples were soaked in deionised water for 1 hour then weighed to determine the saturated weight. The samples were then dried in an oven to constant weight at 120° C. and the dry weight recorded. This was used to calculate the volume of water absorbed by the chalk and allow the percentage porosity to be calculated.

Chalk has porosity between 40 and 50%. By soaking the chalk with glass composition G, for two hours, a reduction in porosity of 50% can be observed. Glass composition G is a glass solution consisting of Na₂O, SiO₂ and CaO ball milled to <45 μm in water.

By reducing the percentage of CaO to in the range 2-4 wt % as in glass compositions H-J, it is possible to prevent the flow of fluid through the rock completely creating an effective seal from the rock, as is shown in FIGS. 2a-c and 3 which provide a comparison between chalk treated with composition H (FIGS. 2a-c) and untreated (FIG. 3) chalk. As can be seen, in particular from a comparison of FIG. 2a and FIG. 3 (both at 100 μm magnification), there is an almost complete sealing of the surface of the treated sample, with the characteristic granular chalk surface (evident in FIG. 3), being replaced by a smooth sealed surface in FIG. 2b. The cracks evident in these images are as a result of surface drying in the laboratory, which would not occur in applications such as oil well sealing due to the presence of ambient moisture. However, even in laboratory tests, permeability tests show that internal sealing is intact, no fluid flows through the cracks, these in themselves being sealed.

### Example 2: Stabilisation of Chalk (Strength without Loss of Permeability)

Under fluid flow conditions chalk has a tendency to form a paste and block pipework used for pumping fluids. Glass composition D, a glass consisting of ZnO, MgO and P₂O₅ finely milled to <10 μm (ball milling) was used to produce a suspension in brine. This suspension was pumped into the chalk and allowed to set for a period of >10 hours at a temperature of 90-100° C. (ambient for underground chalk formations).

After this time water or brine can be pumped through the rock at a rate of 20 ml/min for more than 7 days without the rock losing its integrity and collapsing. Untreated chalk disintegrates under these conditions in just one hour. Porosity tests on chalk treated in this manner retain at least 80% of their initial permeability.

Similar results were observed with glass composition F.

Crushing Strength Measurement: The cold crushing strength of each core was tested using a Houndsfield Compression Tester H25KS. Each core was compressed under increasing load until failure or the instrument threshold of 25,000 N was reached. Two cores from each treatment were crushed the third core was retained for reference. Crushing was carried out using a flat piston of 75 mm diameter until the block failed or the instruments limit of 25,000 N was reached.

Porosity was measured as described in Example 1 above.

Unconfined crush tests on the treated chalk show that it maintains the strength of the original rock despite having fluid passing through it where an untreated sample fails as soon as load is applied. Specifically, FIG. 4a compares the strain to failure at various fluid drawdown pressures for an untreated chalk and a chalk treated with glass composition F. FIG. 4b compares the permeability for the same two samples. It can be seen that there is a significantly greater change in strain exhibited by the reference sample as it deforms and collapses under increased pressure compared to the treated sample which maintains its shape as pressure increases and therefore shows only a very small change in strain with increased drawdown. This change is most clearly shown in the axial tests. In addition, the loss of permeability is around 0.3 mD, showing a good retention of permeability with increasing drawdown pressure, this shows that following an initial increase in permeability in the treated sample it retains over 80% of the initial permeability over time despite treatment with the glass solution. The reference sample maintains permeability as would be expected.

FIGS. 5a and 5b show that there are fewer fractures in chalk cores which have been treated (FIG. 5b) and which have not (FIG. 5a).

It was further noted that, as shown in FIG. 6 for composition P, consistent strength increases were observed relative to the comparative examples (exp 5, 1 and 2) by combining the glass solution with a salt brine solution of for example (exp 3, 6 and 7); sodium or potassium bromide or chloride injection depth and therefore overall core strength improvement was observed, even where residence times were short. Without being bound by theory it is believed that the increased acidic nature of composition D in combination with CI and Br ions slows the formation of precipitate whilst allowing the chalk to dissolve forming “wormholes” into which calcium-phosphate precipitates and reacts improving the tensile strength of the chalk by up to 5-times the natural strength of the chalk substrate without loss of permeability. Further, on the scale tested there was no drop off in strength along the core, the strength increase being as large proximal to the point of injection as distal to this at the point of the core farthest from the injection point.

### Example 3: Stabilisation of Sandstone (Strength without Loss of Permeability)

By adding a solution of glass E in water to a beaker of sandstone that has been crushed in a pestle mortar into a powder (particles size <5 mm) it is possible to replicate natural sandstone, producing a solid mass of material capable of supporting a weight of 2.5 kg without disintegration.

After treatment with the glass E, strength increased over time. The consolidated material can be left soaking in water for 4 weeks and remains intact. Untreated sandstone disintegrated in a few hours under these conditions. A comparison is shown in FIGS. 7a and 7b.

In order to test a larger sandstone sample under flow at simulated oil well temperatures a crushed sandstone sample (particle size <6 mm) was prepared in a Hoek pressure cell and treated with glass composition D at 10% by weight suspension of glass in brine. The setup of the cell is shown in FIG. 8. FIG. 8, shows cell 10, with acrylic spacer ring 15, perforated acrylic disks 20, and a crushed sandstone core 25 within a rubber sleeve 30.

The sample was flooded with 90 ml of composition D. A control with no glass addition was also tested. The cell was heated in a laboratory oven at 90° C. overnight for a minimum of 20 hours then allowed to cool for 3-4 hours. This produced simulated sandstone rock. Confining pressure was applied to the outside of the sample and then water pumped through at 1 bar. The time taken for failure to occur was measured, as failure did not occur water pressure was increased to ˜75 bar by means of a pressure washer pump to induce failure. The level of sand generation was observed by collecting outflow water in a bucket.

The control sample crumbled immediately at pressures of 1 bar.

By changing the composition of the glass similar results have been obtained in limestone and other rock types.

### Example 4: Stabilisation of Clay Brick (Strength without Loss of Permeability)

Treatment of an aged house brick that has begun to crumble using glass composition O containing P₂O₅, CaO, PbO, Na₂O and K₂O in water produces a crust on the surface of the brick when left for several weeks in ambient conditions (see FIG. 9). This crust prevents further deterioration in the surface of the brick material compared to an untreated sample which continues to crumble to a powder that can be brushed away.

### Example 5: Stabilisation of Clay Brick (Two-Step—Sealing)

Glass composition E, was added in water to an aged house brick that has started to crumble and left for 4 hours. A suspension of calcium carbonate in water was then added to the brick sample. The addition of calcium carbonate stimulates a sealing reaction which blocks the pores in the rock, making it impermeable to fluids and creating a waterproof material (FIG. 10). The seal was observed to improve over time.

### Example 6: Stabilisation of the Bored Surface of a Tunnel (Strength and Sealing)

A fluid produced from a calcium, phosphate, silicate containing glass such as glass composition L, in a carrier such as water, can be used to seal a porous or fractured rock substrate (for instance sandstone) in the ceiling of a tunnel during the tunnel boring process, or later where fluid ingress is problematic. The fluid would react with the sandstone resulting in mineralisation which consolidates the rock, sealing pores and small fractures in the rock stabilising the tunnel surface and preventing water seepage.

It is possible to stabilise the floor of the tunnel to improve strength without loss of porosity by applying a glass composition such as composition P. In this way, any water that does seep into the tunnel would drain away through the floor of the tunnel.

It would be appreciated that the fluids, methods and uses of the invention are capable of being implemented in a variety of ways, only a few of which have been illustrated and described above.

1. A fluid for stabilising solids formed from particulate material, the fluid comprising:
glass and a carrier.

2. The fluid according to claim 1, wherein the fluid comprises a solution of glass or a suspension of glass powder in a liquid carrier.

3. The fluid according to claim 1, wherein the fluid comprises a saturated solution of glass in a liquid carrier.

4. The fluid according to claim 1, wherein the fluid is a product comprising glass and a carrier.

5. The fluid according to claim 1, wherein the particle size distribution of the particulate material is in the range 0.01 μm to 2 mm.

6. The fluid according to claim 1, wherein the mean particle size of the particulate material is in the range 1 μm to 1 mm.

7. The fluid according to claim 1, wherein the particulate material is selected from sedimentary rock, soil, or construction materials formed from particulate matter.

8. The fluid according to claim 7, wherein the sedimentary rock is selected from chalk, shale, halides and sandstone.

9. The fluid according to claim 1, wherein when the glass is a suspension of glass powder in the carrier, the particle size distribution of the glass particles is ±15% of the particle size distribution of the particulate material.

10. The fluid according to claim 9, wherein a particle size distribution of the glass powder is in the range 1 μm to 5 mm.

11. The fluid according to claim 1, wherein the glass is a low melting point glass.

12. The fluid according to claim 1, wherein the glass is selected from a sodium, potassium, lithium, sulfate or phosphate glass.

13. The fluid according to claim 1, wherein the glass comprises an oxide selected from SiO₂, Al₂O₃, Fe₂O₃, SO₃, Li₂O, Na₂O, MgO, ZnO, CaO, PbO, PbO₂, BaO, P₂O₃, P₂O₅ or combinations thereof.

14. The fluid according to claim 13, wherein the glass is a phosphate glass additionally comprising an oxide selected from MgO, CaO, SiO₂, Fe₂O₃, Na₂O, PbO and ZnO.

15. The fluid according to claim 13, wherein the glass is a silicate glass additionally comprising an oxide selected from Na₂O, Li₂O and CaO.

16. The fluid according to claim 1, wherein the carrier is selected from water, brine or an alkaline solution.

17. A method for preparing a fluid for stabilising solids formed from particulate material comprising:
melting and fritting a glass;
milling the glass to form a powder; and
adding the milled glass to a carrier.

18. A method of stabilising a solid formed from particulate material, the method comprising mixing the fluid of claim 1 with a particulate material and setting.

19. The method according to claim 18, wherein stabilisation of the solid comprises sealing pores in the solid such that it is impermeable.

20. The method according to claim 18, wherein stabilisation of the solid comprises strengthening the solid to reduce degradation without loss of permeability.

21. The method according to claim 18 wherein stabilisation-comprises a first step of strengthening the solid to reduce degradation without loss of permeability; and a second step of sealing pores in the solid such that it is impermeable.

22. The method according to claim 18, further comprising a step of adding a setting agent to the solid prior to setting,
wherein the setting agent comprises glass of a composition different to the glass in the fluid and/or a non-glass material.

23. Use of a fluid according to claim 1, in geoengineering, building preservation, construction, tunnelling, landscape restoration, land remediation, and/or flood protection/remediation.
